(19) United States
(12) Patent Application Publication
(10) Pub. No.: US 2014/0358716 A1
(43) Pub. Date: Dec. 4, 2014

(54) Website-Based System For Facilitating Real Time Or Near Real Time Negotiations Between Providers and Purchasers

(71) Applicants: Tim Kaufeldt, San Antonio, TX (US); Nathan Alden, SR., Austin, TX (US)

(72) Inventors: Tim Kaufeldt, San Antonio, TX (US); Nathan Alden, SR., Austin, TX (US)

(73) Assignee: TANKSOFT LLC, San Antonio, TX (US)

(21) Appl. No.: 14/292,906

(22) Filed: May 31, 2014

Related U.S. Application Data
(60) Provisional application No. 61/830,030, filed on May 31, 2013.
(60) Provisional application No. 61/917,381, filed on Dec. 18, 2013.

(51) Int. Cl. G06Q 30/06

(52) U.S. Cl. CPC G06Q 30/0611
USPC 705/26.4

(57) ABSTRACT

In an electronic negotiation system, a web server stores seller information characterizing an offer. The electronic negotiation system provides for sending and receiving buyer and seller information regarding the offer where the information exchanged includes buyer and seller interest in the offer and a versatility in at least one of the seller defined parameters characterizing the offer. These electronic exchanges may be characterized as occurring in near real-time.

### CROSS-REFERENCE TO RELATED APPLICATIONS

This application claims priority to U.S. Provisional Patent Application Ser. No. 61/830,030 (“Parent Provisional One”), filed 31 May, 2013. This application also claims priority to U.S. Provisional Patent Application Ser. No. 61/917,381 (“Parent Provisional Two”), filed 18 Dec., 2013. Collectively, Parent Provisional One and Parent Provisional Two shall be hereinafter referred to as comprising “Related References”. The subject matter of all of the Related References, each in its entirety, is expressly incorporated herein by reference.

### FIELD OF THE INVENTION

This disclosure relates generally to field of automating of bargaining for goods and services, and more specifically to providing real-time, or near real-time automated multilateral offer and acceptance systems.

### BACKGROUND OF THE INVENTION

Bargaining or haggling is a type of negotiation where buyers and sellers of goods and/or services do not agree on the initial price and value but eventually come to an agreement after several offers and counter offers and establishing an acceptable price vs. value. As an example, retailers may post a price on goods sold or services offered but may choose to allow bargaining, thus allowing the retailer to price discriminate between different types of customers. Likewise, what constitutes price and value between participants in local commerce may be based not only on price alone, but may include bargain, exchange, trade, or barter and may includes conveniences such as pickup, delivery, storage and the like. These types of barter or convenience factors are not historically taken into account in today's typically Internet marketing systems.

Internet marketing systems typically rely on at least one of several systems for item-price determination. Those systems include: (1) fixed price via retail site or classified ad-type listing such as on-line retailers or on-line ad-listing sites; (2) auction style format, with some set parameters such as large online auction sites; (3) auction style format with buy it now/set price option; and (4) auction style format with make offer options, requiring negotiations via electronic email. These systems do not account for convenience factors or barter factors that may dramatically alter what constitutes price and value.

Unlike existing classified boards or auction-style systems, a more effective method and apparatus may provide buyers the opportunity to make offers for the product or services in real-time/near real-time, in a centralized communication portal in an electronic negotiation format. For purposes of familiarity and ease of use, the offers and responses may appear in “speech bubble” type windows that would be very familiar to any person that has ever used text messaging on a mobile device, or instant messaging (IM) on a laptop or desktop computer. Access to and use of email would no longer be required to make offers, nor would it be required to respond to offers—everything would happen directly within the electronic negotiation format itself By facilitating this direct, digital “face-to-face” negotiation, atypical factors may be considered in the negotiation process and expand constitutes “price” and “value”.

Thus a need exists for a method and apparatus that provides a more effective means of negotiating electronically where atypical factors may be integrated into the negotiation process in real-time or near real-time.

### BRIEF SUMMARY OF THE INVENTION

In accordance with some embodiments of our invention, we provide an apparatus and a method for electronically conducting negotiations is disclosed. The apparatus comprises a web server that includes a processor and memory. The apparatus executes a plurality of software applications that collectively provide a negotiation engine. The apparatus also includes a database, a communication network and a plurality of clients, wherein the plurality of clients are operable to execute a web browser application. The web server is operable to store a plurality of offer information in the database comprising. The database comprises a plurality of offers listed by a seller by way of the plurality of clients, each of the plurality of offers listed by the seller further comprising a plurality of selling criteria, wherein the plurality of selling criteria comprises a plurality of seller-defined parameters characterizing the offer. The web server is also operable to receive a plurality of information from a buyer by way of the plurality of clients over the communication network. The plurality of information from the buyer further comprises a plurality of buying criteria, wherein the buying criteria comprises a type of buyer interest and a versatility in at least one of the plurality of seller-defined parameters characterizing the offer. The web server is also operable to transmit the plurality of information from the buyer to the seller over the communication network, wherein the transmission is characterized as near real-time. The web server is also operable to receive a plurality of information from the seller by way of the plurality of clients over the communication network. The plurality of information from the seller further comprises a plurality of selling criteria, wherein the selling criteria comprises a type of seller interest and a versatility in at least one of the plurality of seller-defined parameters characterizing the offer. The web server is also operable to transmit the plurality of information from the seller to the buyer over the communication network, wherein the transmission is characterized as near real-time.

### BRIEF DESCRIPTION OF THE DRAWINGS

FIG. 1 illustrates in block diagram form an electronic negotiation system according to some embodiments;

FIG. 2 illustrates in flow chart form, a seller's method according to some embodiments;

FIG. 3 illustrates in flow chart form, a buyer's method according to some embodiments;

FIG. 4 illustrates in flow diagram form, a method for conducting an electronic negotiation utilizing the electronic negotiation system of FIG. 1 according to some embodiments; and

FIG. 5 illustrates in diagram form a web browser window wherein an electronic negotiation is occurring as illustrated in FIG. 4 and as described herein.

In the drawings, similar elements will be similarly numbered whenever possible. However, this practice is simply for convenience of reference and to avoid unnecessary proliferation of numbers, and is not intended to imply or suggest that our invention requires identity in either function or structure in the several embodiments.

### DETAILED DESCRIPTION

### A. Illustrative Electronic Negotiation System

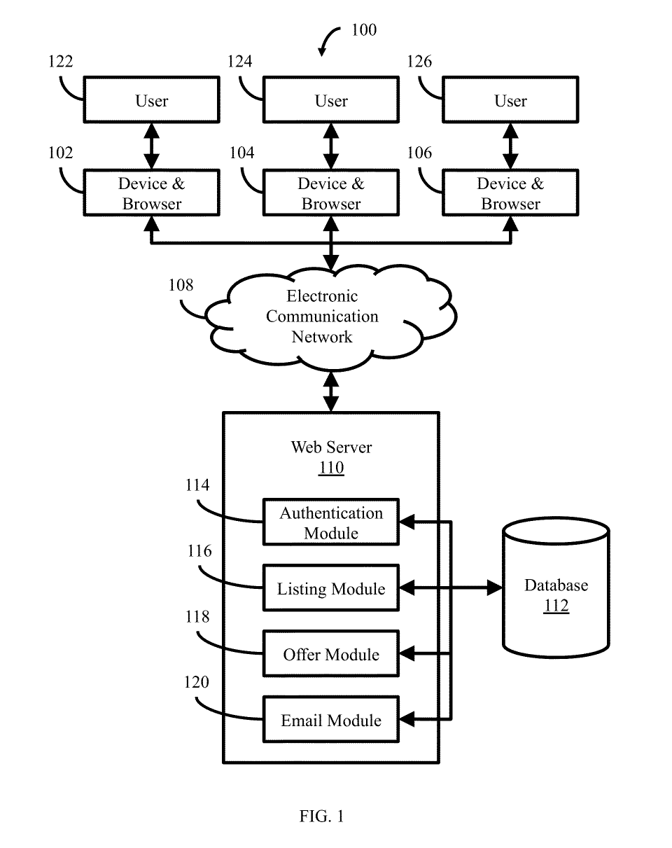

FIG. 1 illustrates in block diagram form an electronic negotiation system 100 for conducting negotiations according to some embodiments of our invention. The electronic system 100 generally includes multiple devices or clients that are operable to execute a web browser application. These multiple devices or clients include, but are not limited to, laptop devices 102, smartphone devices 104, and tablet devices 106. Other devices that are operable to execute a web browser application are anticipated and that are well understood by one of ordinary skill in this art. These devices are anticipated to support at least one of the multiple browser applications as they are understood by one of ordinary skill in this art. Electronic negotiation system 100 also generally includes an electronic communication system 108. While other forms of electronic communications are anticipated, electronic communication system 108 is generally understood by those of ordinary skill in the art to be the Internet upon which so many of modern day applications operate. Electronic negotiation system 100 also generally includes at least one Web Server 110. The Web Server 110, as generally understood by one of ordinary skill in this art, refers to the hardware and the software that helps deliver web content that can be accessed through the Internet. The hardware may be as simple as a laptop computer with its requisite memory and disk drive or as complex as modern day blade servers with their large numbers of processors, memory and disk. The software may be any one of the free application server software packages or one of the fee based application server software packages generally known to one of ordinary skill in this art. Electronic negotiation system 100 also generally includes a database 112 which is generally understood to be an organized collection of electronic data accessed by software database management systems. Database 112 includes information on sellers and buyers. Database 112 also includes information on goods and services seller wishes to offer for sale. These may be more commonly known at “deals”. This information regarding goods and services offered for sale may include a set of selling parameters or selling criteria such as a description, digital images or photographs, diagrams and a set of parameters or criteria that further characterize price and value. These parameters or criteria that characterize price and value may be an initial price, but may also include, but not be limited to offers of barter and trade and convenience factors like pickup and delivery adjustments to a base price. Software database management systems are specifically designed to interact with users or other applications and the database 112 itself, to edit, search, capture and analyze the data contained in the database 112, and to provide the results back to the users or other applications.

Web Server 110 generally includes a number of modules according to some embodiments of our invention. These modules include, but are not limited to, an authentication software module 114, a listing software module 116, an offer software module 118 and an email module 120. Authentication module 114 generally is a software security mechanism that integrates low-level authentication schemes known to those of ordinary skill in this art and used to prevent hacking of the electronic negotiation system 100 as well as authenticate registered users from guest users and allow registered users to take advantage of capabilities within the electronic negotiation system 100 that are unavailable to guest users. Listing module 116 generally is a software mechanism that accepts specific data from users characterizing the specific good or service the user wishes to offer on the electronic negotiation system 100. The data characterizing the good or service is stored by the listing module 116 in the database 112. Offer module 118 generally is a software mechanism that interacts with users that are both buyers and sellers by facilitating real-time or near-real-time communications and negotiations between buyers and sellers via a user interface as well as displaying the good or service being offered to active users and guests. The email module 120 generally is a software mechanism that provides email notification to users, both buyers and sellers. One use of this email module, according to some embodiments of our invention, is to provide these email notifications when one user has made a responsive communication with another user who may be offline. As an example, a buyer may make an offer on a good or service and if the seller of that good or services has enabled notification services, that seller will be sent an email notification that an offer is pending.

During operation, users 122, 124 and 126 may be either a buyer, a seller, or in some cases, may be both. Users 122, 124 and 126 send communications requests via an Internet browser application through the electronic communications system 108, also generally understood as the Internet, using their respective devices 102, 104 and 106. The browser transports all incoming communication requests through the Internet 108. The Internet 108 delivers incoming communications requests to the Web Server 110. Web Server 110 parses all incoming communication request to the appropriate module or modules. Authentication Module 114, listing module 116, offer module 118 and email module 120 each provide software calls requesting required information from the database 112. The database 112 responds to those software calls by processing the request and providing the requested information back to the originating module or modules. Once the requesting module has received the requested information and completes its processing, that module returns the required responses to the Web Server 110. The Web Server 110 delivers outgoing responses to the requesting device and browser via the Internet 108. In response to receiving the requested information, the requesting browser application displays the information to the user.

### B. Illustrative Seller's Method

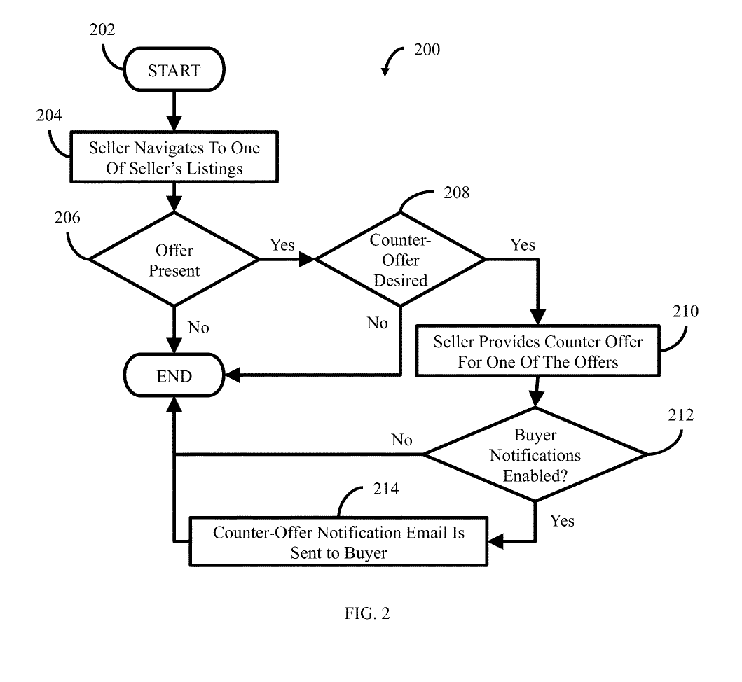

Although users 122, 124 and 126 illustrated in FIG. 1 perceive their interaction to be direct, real-time or near real-time communications, the offer module 118 illustrated in FIG. 1 supplies their responsive communications via two separate processes, a seller's method 200 and a buyer's method 300, moderated and processed by Web Server 110. FIG. 2 illustrates in flow chart form, a seller's method 200 according to some embodiments of our invention. Seller's method 200 assumes at START 202 that one of users 122, 124 or 126 who is a seller of goods or services (“Seller”) has navigated to the website representing the electronic negotiation system 100, signed up for services and created a listing on the electronic negotiation system 100 for the good or service Seller wishes to offer for sale. Seller then navigates to one of their listed goods or services 204. If an offer is present 206 and a counter-offer is desired 208, Seller provides a counter-offer for one of the offers 210. If, however, no offer is present 206, the method and process terminate. Once Seller has provided a counter-offer, if one of the other users is an interested buyer has navigated to the website, signed up for services and has enabled email notification services 212, the counter-offer provided by Seller is emailed to that user 214. If the interested buyer has not enabled email notification services, the method and process terminate. Users who are Sellers may be, but are not limited to an individual selling goods or services, a freelance contractor seeking contract- or project-based employment, an employer seeking candidates for employment or a retail establishment listing inventory for sale. Other purposes are anticipated.

### C. Illustrative Buyer's Method

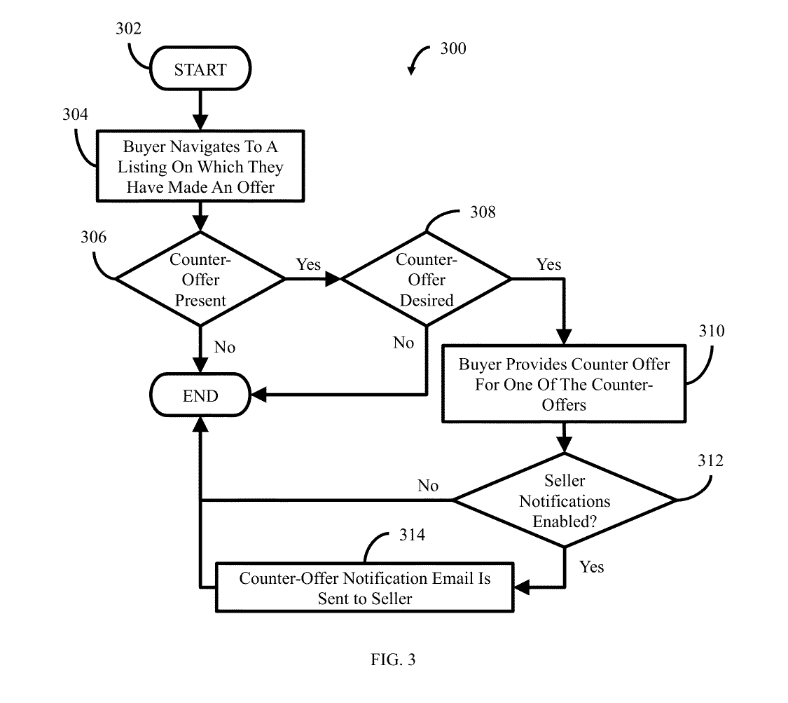

FIG. 3 illustrates in flow chart form, a buyer's method 300 according to some embodiments of our invention. Buyer's method 300 assumes at START 302 that one of users 122, 124 or 126 who is a buyer of goods or services (“Buyer”) has navigated to the website representing the electronic negotiation system 100, identified a listing of interest via browsing and/or search functionality, and has submitted an offer. Buyer then navigates to one of the listed goods or services on which Buyer has made an offer 304. If an counter-offer is present 306 and a counter-offer is desired 308, Buyer provides a counter-offer for one of the counter offers 310. If, however, no offer is present 306 , the method and process terminate. Once Buyer has provided a counter-offer, if one of the other users is a Seller has navigated to the website, signed up for services and has enabled email notification services 312, the counter-offer provided by Buyer is emailed to that user 314. If the interested buyer has not enabled email notification services, the method and process terminate. Users who are Buyers may be, but are not limited to an individual seeking goods or services, a company seeking contract- or project-based employees or an unemployed person seeking employment. Other purposes are anticipated.

### D. Illustrative Operation

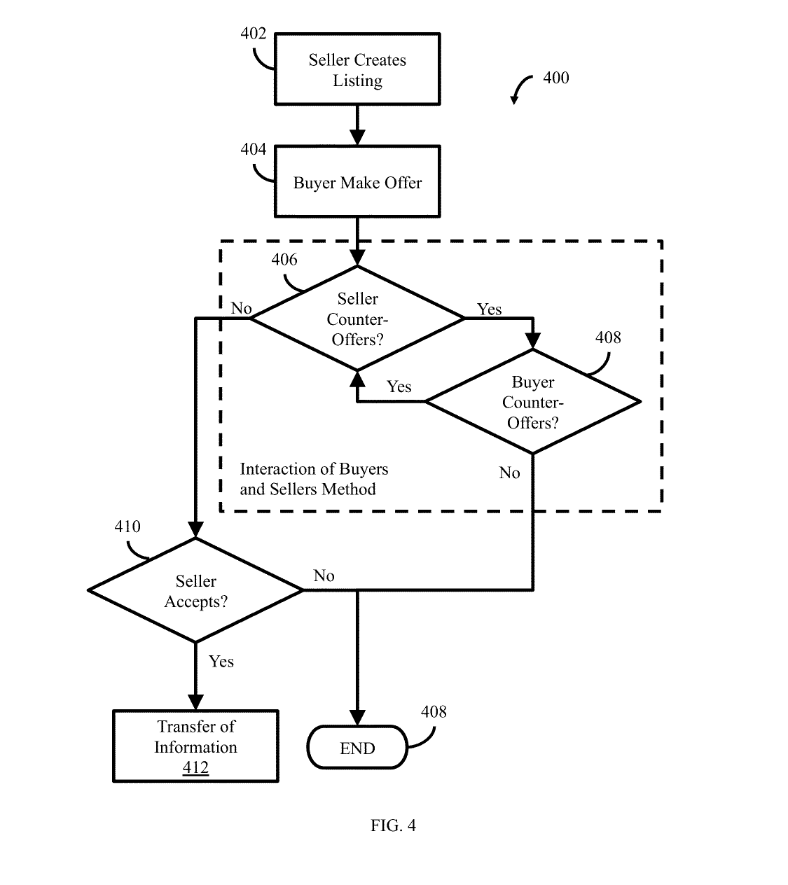

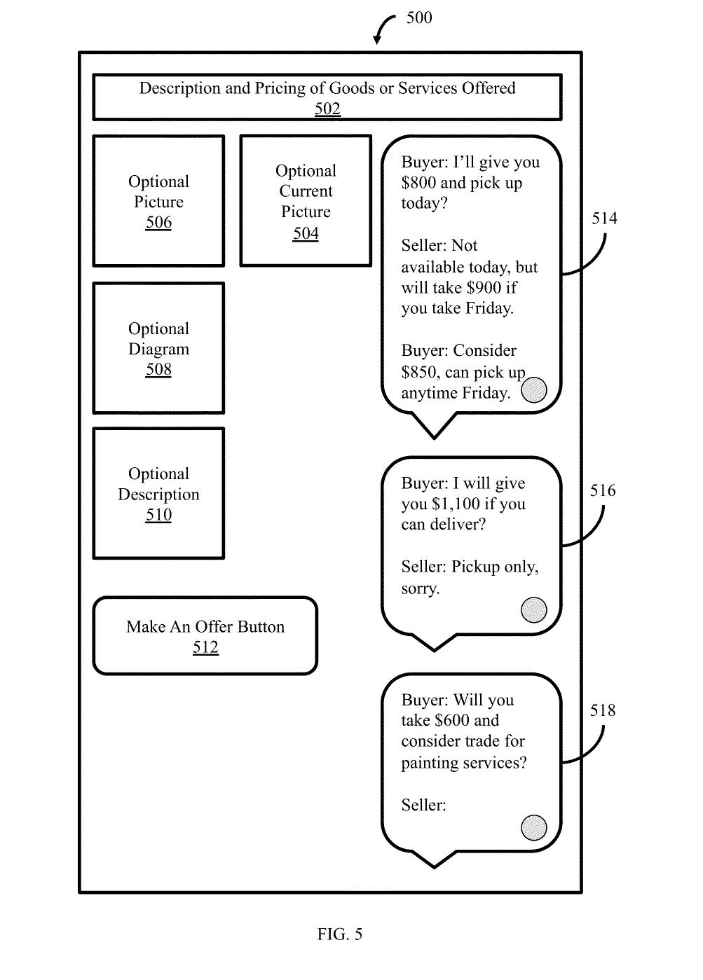

FIG. 4 illustrates in flow diagram form, a method for conducting an electronic negotiation 400 utilizing the electronic negotiation system 100 of FIG. 1 according to some embodiments. FIG. 5 illustrates in diagram form a web browser window 500 wherein an electronic negotiation is occurring as illustrated in FIG. 4 and as described herein. As previously mentioned, the method of conducting an electronic negotiation utilizing the electronic negotiation system 100 of FIG. 1 begins with a Seller posting a seller created listing 402. Referring to FIG. 5, the web browser window 500 generally includes description of the good to be sold or services offered 502 as well as an optional picture or diagram of the good or service 504. Web browser window 500 may also include additional optional pictures 506, diagrams 508, or descriptions 510. All of these elements of web browser window 500 are established initially by Seller and may be updated by any number of means of modifying web pages that are well known to one of ordinary skill in this art. Referring back to FIG. 4, a potential Buyer, who has navigated to the website representing the electronic negotiation system 100 of FIG. 1, identified a listing of interest via browsing and/or search functionality, submits an offer 404. Referring to FIG. 5, submitting a Buyer's offer is accomplished by clicking the “Make an Offer” button 512 which in turn opens an interactive window with which the Buyer and Seller may communicate in real time or near real time. According to some embodiments of our invention, this interactive window is represented as “speech bubble” 514, 516 and 518. Creation of these interactive windows or “speech bubbles” is accomplished via software techniques well known to one of ordinary skill in this art. Referring back to FIG. 4, the Web Server 110 moderates and separately processes the sellers method 200 of FIG. 2 and buyers method 300 of FIG. 3 to facilitate the real-time or near real-time communication between Seller and Buyer. This interaction between sellers method 200 and buyers method 300 is illustrated in FIG. 4 as the interaction between seller's counter offer 406 and buyers counter offer 408. During this interaction, buyers and sellers may alter the selling parameters or criteria by mutual agreement via real-time or near real-time electronic negotiations displayed in the interactive windows or “speech bubbles”. This versatility in the selling parameters supports closure of the negotiations by allowing the buyer to express a level of interest and offer alternative options to the seller's selling parameters. This interaction continues until the Buyer fails to provide a counter offer, thus ending the electronic negotiation 408, or the Seller fails to provide a counter offer and either accepts the offer provided 410 by the Buyer or ends the electronic negotiation 408. If Seller accepts the offer provided by the Buyer, the parties exchange information necessary to facilitate the agreed exchange. As discussed earlier, this real-time or near real-time interaction is illustrated in FIG. 5 as “speech bubble” 514, 516 and 518. Analogous to a public auction or bazaar, buyers and sellers may electronically negotiate based not only on price alone, but on atypical factors such as barter, exchange, or convenience factors.

Thus it is apparent that we have provided a method and apparatus that provides a more effective means of negotiating electronically where atypical factors may be integrated into the negotiation process in real-time or near real-time. Those skilled in the art will recognize that modifications and variations can be made without departing from the spirit of our invention. Therefore, we intend that our invention encompass all such variations and modifications as fall within the scope of the appended claims.

What we claim is:

1. A system for electronically conducting negotiations, said system comprising:
a web server having a processor and memory, said computer system executing a plurality of software applications that collectively provide a negotiation engine;
a database;
a communication network;
a plurality of clients, wherein said plurality of clients are operable to execute a web browser application;
wherein said web server is operable to:
store a plurality of offer information in said database comprising:
a plurality of offers listed by a seller by way of said plurality of clients, each of said plurality of offers listed by said seller further comprising a plurality of selling criteria, wherein said plurality of selling criteria comprises a plurality of seller-defined parameters characterizing the offer;
receive a plurality of information from a buyer by way of said plurality of clients over said communication network, said plurality of information from said buyer further comprising:
a plurality of buying criteria, wherein said buying criteria comprises a type of buyer interest and a versatility in at least one of said plurality of seller-defined parameters characterizing the offer;
transmit said plurality of information from said buyer to said seller over said communication network, wherein said transmission is characterized as near real-time;
receive a plurality of information from said seller by way of said plurality of clients over said communication network, said plurality of information from said seller further comprising:
a plurality of selling criteria, wherein said selling criteria comprises a type of seller interest and a versatility in at least one of said plurality of seller-defined parameters characterizing the offer; and
transmit said plurality of information from said seller to said buyer over said communication network, wherein said transmission is characterized as near real-time.

2. A method for electronically conducting negotiations, said method comprising:
storing a plurality of offer information comprising:
a plurality of offers listed by a seller, each of said plurality of offers listed by said seller further comprising a plurality of selling criteria, wherein said plurality of selling criteria comprises a plurality of seller-defined parameters characterizing the offer;
receiving a plurality of information from a buyer, said plurality of information from said buyer further comprising:
a plurality of buying criteria, wherein said buying criteria comprises a type of buyer interest and a versatility in at least one of said plurality of seller-defined parameters characterizing the offer;
transmitting said plurality of information from said buyer to said seller, wherein said transmission is characterized as near real-time;
receiving a plurality of information from said seller, said plurality of information from said seller further comprising:
a plurality of selling criteria, wherein said selling criteria comprises a type of seller interest and a versatility in at least one of said plurality of seller-defined parameters characterizing the offer; and
transmitting said plurality of information from said seller to said buyer, wherein said transmission is characterized as near real-time.
